(19) United States
(12) Patent Application Publication
(10) Pub. No.: US 2016/0144588 A1
(43) Pub. Date: May 26, 2016

(54) METHOD FOR WARPING THE MACHINE BED AND/OR THE PRESS RAM OF A PUNCHING PRESS AND PUNCHING PRESS

(71) Applicant: BRUDERER AG, Frasnacht (CH)

(72) Inventor: Josef Thomas Hafner, Rorschacherberg (CH)

(21) Appl. No.: 14/899,775

(22) PCT Filed: Jun. 19, 2013
(86) PCT No.: PCT/CH2013/000107

§ 371 Date: Dec. 18, 2015

(51) Int. Cl. B30B 15/04; B30B 15/00; B30B 15/34; B21D 22/02

(52) U.S. Cl. CPC B30B 15/042; B21D 22/02; B30B 15/007; B30B 15/34

(57) ABSTRACT

The invention relates a method for warping the machine bed and/or the press ram of a punching press to compensate at least partially a bending caused by the punching force of the machine bed or the press ram during punching operation, respectively. For this a temperature gradient is generated selectively within the machine bed and/or within the press ram according to the invention, with the effect of making the machine bed warping in the direction towards the press ram and/or the press ram warping in the direction towards the press bed.

In this way, machine beds and press rams of punching presses can be pre-deformed for the compensation of bendings caused by the punching force with a very small expenses on the equipment side, without having to deviate from existing and proven structure concepts. Additionally the method according to the invention can be applied to existing presses.

### CROSS REFERENCE TO RELATED APPLICATION

Applicant hereby claims priority benefits under U.S.C. §119 from International Patent Application Serial No. PCT/CH2013/000107 filed on Jun. 19, 2013, the contents of which are incorporated by reference herein.

### TECHNICAL FIELD OF THE INVENTION

The present invention relates to a method for warping the machine bed and/or the press ram of a punching press to compensate at least partially a bending caused by the punching force during punching operation and a punching press, in particular to perform the method, according the preambles of the independent claims.

### BACKGROUND OF THE INVENTION

For the industrial manufacturing of punching parts from metal strips, fast running automatic punching machines are used nowadays, at which an upper tool part with punches is moved over a certain stroke towards a lower tool part with dies and makes cuts and shapings at the metal strip by doing so. The today's, so called progressive dies, which mostly comprise a larger quantity of modules, which handle different tasks like cutting, bending, metal forming and stamping, call for more and more longer tool installation spaces.

Correspondingly the length of the tool installation spaces of automatic punching machines has practically been doubled for the last three decades at unchanged tonnage, which leads to a corresponding growth of the moved and unmoved masses due to the longer components and at the same time to problems with the stiffness of the press structure, because the stiffness typically decreasing due to the increase of the length of some critical components, in particular of the machine bed and the press ram, cannot be arbitrarily compensated by corresponding increases of cross section due to limited available space.

Hereby again there is the problem that it is more and more difficult with increasing length of the tool installation space to keep the deformations of the press structure and in particular the bending of the machine bed under punching load, which should be as small as possible for a high process precision and a little tool wear within passable limits. In particular for the case that punching work is performed in the rather unusual punching direction from back to front, these bendings are a big problem.

For reducing or at best even for compensating the bending of machine beds or tool clamping plates, respectively, under the process load, it is known from prior art to warp the machine bed or the tool clamping plate against the bending direction, preferably such that this warping is just canceled by the process load, or however to support the tool clamping plate dynamically with height adjustable supporting elements on a supporting structure possibly bending under the process load, that the tool clamping plate is not bended essentially under the load.

Like that, a press is known from EP 0 653 254 A2, at which support elements are arranged between the press bed and the tool clamping plate, which are adjustable in height. These support elements can be of a mechanical, electromechanical or hydraulic nature and can be operated by a controller such that it is counteracted the deformation of the tool clamping plate under the working pressure of the press. It is also possible to produce with these support elements a warp of the clamping plate to compensate tool characteristics.

A machine table with a tool clamping plate for presses in the sector of metal forming is known from DE 44 15 577 A1, at which a plurality of hydraulic compensation pistons are arranged between a base plate and a tool clamping plate. There are present range sensors or bending sensors, respectively, and a suitable controller to control the pressure in the compensation pistons such that it counteracts a deformation of the tool clamping plate under the working pressure of the press.

The systems known from EP 0 653 254 A2 and DE 44 15 577 A1 have basically the disadvantage that they are mechanically complex and therefore their production and maintenance is elaborate and cost-intensive, and that they allow a relatively low structural stiffness for the needed construction height due to their construction principle with multiple punctual support of the tool clamping plate in the punching direction on a supporting structure lying under it. For the variants with hydraulic support elements/compensation pistons, there is the additional disadvantage that the supporting oil cushion has a low stiffness in the punching direction and that the inevitable deformations of the entire hydraulic system under the oil pressure produced by the supporting pressure lead to a deflection of the support under the punching load. For the variants, at which a bending of the tool clamping plates shall be avoided by a dynamic height adjustment of supporting elements, it is to say that, if realizable at reasonable costs, these possibly suit for very slow metal forming processes, but not for fast automatic punching machines for processing metal strips by the progressive die process.

A press is known from DE 100 10 197 A1, at which the machine bed can be warped in the direction towards the press ram by pre-loading of tie-rods longitudinally crossing the machine bed in the lower area to correct a bending of the press bed or to produce a warping in the unloaded state. There is present a controller, by which the pre-loading of the tie-rods can be controlled depending on detected warps. This last-mentioned system avoids the disadvantages mentioned before of the two first mentioned systems as far as possible, but has the disadvantage that the machine bed has to be constructed specifically for this functionality, such that it has to be deviated from existing and tested structure concepts and that equipping of existing presses with the system is hardly possible.

### SUMMARY OF THE INVENTION

Therefore an objective is to provide a technical solution which does not show the previously mentioned disadvantages of the prior art or avoids these at least partially, respectively, or at least represents an alternative to the existing systems.

This objective is achieved by the method and the punching press according to the independent claims.

According to these, a first aspect of the invention concerns a method for warping the machine bed and/or the press ram of a punching press to compensate at least partially a bending of the machine bed or the press ram, respectively, caused by the punching force during the punching process. For this, according to the invention, a temperature gradient specifically is produced specifically within the machine bed or within a supporting structure for the lower tool elements built with the machine bed, respectively, and/or within the press ram or a supporting structure for the upper tool elements built with the press ram, respectively, by means of which temperature gradient the machine bed warps in the direction towards the press ram and/or the press ram warps in the direction towards the press bed.

By the method according to the invention, machine beds and press rams of punching presses can be pre-deformed by very little expenses on the equipment side for the purpose of at least partially compensating bendings caused by punching forces without having to deviate from existing and tested structure concepts. This is of outstanding significance particularly in the field of fast operating high performance automatic punching machines, because detail work for years is often needed here to optimize the press structure with respect to its dynamic behavior and to its life time. Additionally the method according to the invention can be applied with little effort also to existing presses.

In a preferred embodiment of the method, the temperature gradient effecting the warp is produced by heating the machine bed in the area of its side facing the press ram or by heating the press ram in the area of its side facing the machine bed, respectively. The local heating is a particularly simple and often also economical method to produce a temperature gradient, in particular because waste heat is often available for free at production lines.

Alternatively or additionally it is preferred to produce the temperature gradient by cooling the machine bed in the area of its side facing away from the press ram or by cooling the press ram in the area of its side facing away from the machine bed, respectively. This method is particularly appropriate if these machine components get very warm in operation and can be cooled locally in this way without having undershootings of dew point with condensation of water at machine parts.

The introduction of heat and/or coldness into the parts can be performed in different ways.

For this, in a preferred embodiment of the method, flow channels arranged within the machine bed or within the press ram, respectively, are flowed through by a heated or cooled, respectively, gaseous of liquid medium. For this for example, heated lubricating oil of a lubricating oil circuit of the press can be used which is guided through the flow channels before cooling back. Last mentioned method has the advantage that no additional energy is needed for heating.

In a further preferred embodiment of the method, electrical heating elements are arranged within the machine bed or within the press ram, respectively, and are charged with electric current for producing heat. At this variant, there is the advantage that precise and control of the temperature gradient adjusted to the particular operation is possible with very simple means.

In an even further preferred embodiment of the method, the temperature gradient is produced in that a clamping plate is arranged on the machine bed, which is heated.

In another preferred embodiment of the method, a clamping plate is arranged on the machine bed and a heating device is arranged between the machine bed and the clamping plate, which is heated.

Thereby, according to a preferred variant of these two embodiments, the machine bed is heated by the heated clamping plate or by the heating device arranged between the machine bed and the clamping plate at its side facing the ram, with the consequence that there is a warp of the machine bed in the direction towards the press ram.

According to another preferred variant of these two embodiments, the clamping plate is connected in a shear stiff manner with the machine bed, directly or over the heating device. At this variant, the warp of the machine bed in the direction towards the press ram can also be done exclusively as a consequence of an introduction of shear forces, produced by a thermal expansion of the clamping plate, into the side of the machine bed facing the ram, or also in combination with a heating of the machine bed by the clamping plate or by the heating device, respectively.

Many punching presses have an aperture in the machine bed for carrying away punched parts and rubbish. At such presses, it is preferred that the temperature gradient within the machine bed is produced such that the machine bed warps stronger in the area adjacent to the aperture in the direction towards the press ram than in the areas adjacent to the longitudinal sides of the machine bed. Hereby it follows an improved compensation of the bending under punching load because the machine bed of such presses typically undergoes a bigger bending in the area around the aperture than in the area of its longitudinal sides under the punching load.

To produce such a warp, it is preferred to heat the machine bed in the area of its side facing the press ram near to the boundaries of the aperture or to stronger heat it in that area than near to its longitudinal sides, respectively.

Alternatively or additionally it is preferred to reach such a warp by cooling the machine bed in the area of its side facing away from the press ram near to the boundaries of the aperture or to stronger cool it in that area than near to the longitudinal sides, respectively.

In an even further preferred embodiment of the method, it is preferred that the warp of the machine bed or the press ram, respectively, is adjusted depending on parameters of the punching process, for example depending on a pre-calculated or product-specific punching force, respectively, or depending on a maximal punching force measured during operation. Further it is preferred that the warp is adjusted during the intended operation of the press. In this way, the respective operating situation can particularly well be accommodated and possible changes, for example due to additional tool wear, can be accommodated.

A second aspect of the invention relates to a punching press which is suitable for performing the method according to the first aspect of the invention. The punching press has a machine bed and a press ram working against the machine bed. Further the punching press comprises means for warping the machine bed in the direction towards the press ram and/or for warping the press ram in the direction towards the machine bed by producing a temperature gradient within the machine bed or within a supporting structure for the lower tool elements built with the machine bed, respectively, and/or within the press ram or supporting structure for the upper tool elements built with the press ram, respectively.

By the invention it becomes possible to provide cost-efficient, highly precise, fast running high performance punching presses with compensation of bending without deviating from proven structure concepts.

In a preferred embodiment of the punching press, the means for warping the machine bed or the press ram, respectively, are built such that the machine bed in the area of its side facing the press ram or the press ram in the area of its side facing the machine bed, respectively, can be heated by them for effecting the warping due to a non-uniform heating with corresponding non-uniform spatial expansion of them.

Alternatively or additionally the means for warping the machine bed or the press ram, respectively, are built such that the machine bed in the area of its side facing away from the press ram or the press ram in the area of its side facing away from the machine bed can be cooled by them for effecting the warping due to a non-uniform cooling with corresponding non-uniform spatial shrinkage of them.

For introducing heat or coldness the punching press according to the invention can have different arrangements:

In a preferred embodiment of the punching press, flow channels are arranged within the machine bed or within the press ram, respectively, which are flowed through by a heated or cooled, gaseous or liquid medium during intended operation for producing the temperature gradient.

With advantage, arrangements exist according to a preferred variant of this embodiment, by means of which heated lubricating oil of a lubricating oil circuit of the press can be passed through the flow channels during the intended operation of the press for producing the temperature gradient. This solution is energetically very advantageous because practically no heating energy is needed to provide the heat.

In a further preferred embodiment of the punching press, electric heating elements, in particular resistance heating elements, are arranged within the machine bed or within the press ram, respectively, which can be charged with electric current during the intended operation of the press for producing the temperature gradient effecting the warping. This construction allows a particularly good controllable production of the temperature gradient.

In an even further preferred embodiment, the punching press has a clamping plate arranged on its machine bed which clamping plate can be heated, in particular electrically, during the intended operation of the press.

In another preferred embodiment, the punching press has a clamping plate arranged on its machine bed, wherein a in particular electrical heating device, is arranged between the machine bed and the clamping plate which can be operated during the intended operation of the press.

Thereby according to a preferred variant of these two embodiments, the clamping plate or the heating device arranged between the clamping plate and the machine bed, respectively, are connected with the machine bed such that the clamping plate, if it is heated, or that the heating device, if it is operated, respectively, heats the machine bed at the side facing the ram for producing the temperature gradient effecting the warp.

According to another preferred variant of these two embodiments, the clamping plate is connected with the machine bed in a shear stiff manner, directly or over the heating device.

Thereby according to a first preferred sub-variant, the heatable clamping plate or the heating device arranged between the clamping plate and the machine bed, respectively, is basically thermally decoupled from the machine bed such that it comes basically to a heating up and a corresponding expansion of the clamping plate during heating the clamping plate or during operating of the heating device, respectively, by means of which the warp of the machine bed in the direction towards the press ram is caused due to the shear stiff coupling of the clamping plate to the machine bed.

According to a second preferred sub-variant, the clamping plate is connected with the machine bed such that it, if it is heated, heats the machine bed at its side facing the ram, or the heating device arranged between the clamping plate and the machine bed is connected with the clamping plate and the machine bed such that it, if it is operated, heats the clamping plate and the machine bed at its side facing the ram. By this embodiment, during heating the clamping plate or during operating the heating device, respectively, the warp of the machine bed is caused by shear forces introduced by the clamping plate into the machine bed in combination with the non-uniform spatial expansion resulting due to the non-uniform heating of the machine bed.

The use of heatable clamping plates or of heating devices arranged between the machine bed and the clamping plate is suitable particularly well for the cheap retrofit of existing punching presses.

If the machine bed of the punching press has an aperture for carrying away punching parts and rubbish, which is the case at most fast running punching presses, it is an advantage that the means for warping the machine bed are built such that they produce the temperature gradient within the machine bed such that the machine bed in the area adjacent to the aperture warps stronger than in the area adjacent to its longitudinal sides. Hereby, it arises an improved compensation of the bending under punching load because the machine bed of such presses typically undergoes a bigger bending in the area around the aperture than in the area of its longitudinal sides under the punching load.

Preferably, the means for warping the machine bed are built for this such that the machine bed can be heated with them in the area of its side facing the press ram near to the boundaries of the aperture or can be heated more in these areas than near to the longitudinal sides, respectively.

Alternatively or additionally, the means for warping the machine bed are built for this such that the machine bed can be cooled with them in the area of its side facing away the press ram near to the boundaries of the aperture or can be cooled more in these areas than near to the longitudinal sides, respectively.

With advantage, the means for warping the machine bed or the press ram, respectively, can be adjusted and indeed preferably during the intended operation of the press such that an adjustment, specific and suitable for each operating case, of the warp of the machine bed or the press ram, respectively, is possible.

For this, the punching press has preferably a press control by means of which the warp of the machine bed or the press ram, respectively, is adjustable, preferably automatically, depending on parameters of the punching process, preferably depending on a calculated or product-specific punching force, respectively, or a maximal punching force measured during operation, and indeed preferably during the intended operation of the press. Hereby, a process control with automatic adjustment of the warp of the machine bed or the press ram, respectively, to the particular operating conditions is possible.

### BRIEF DESCRIPTION OF THE DRAWINGS

Further preferred embodiments of the invention result from the dependent claims and from the now following description by means of the figures. Thereby it show:

FIG. 1 a sectional view through an automatic punching machine with top drive;

FIG. 2 a section through the machine bottom part of the automatic punching machine along the line X-X in FIG. 1;

FIG. 3 a view like in FIG. 2 through the bottom structure of a first automatic punching machine according to the invention;

FIG. 4 a view like in FIG. 2 through the bottom structure of a second automatic punching machine according to the invention;

FIG. 5 a sectional view through an automatic punching machine with bottom drive according to the invention; and

FIG. 6 a sectional view through a further automatic punching machine with bottom drive according to the invention.

### DETAILED DESCRIPTION

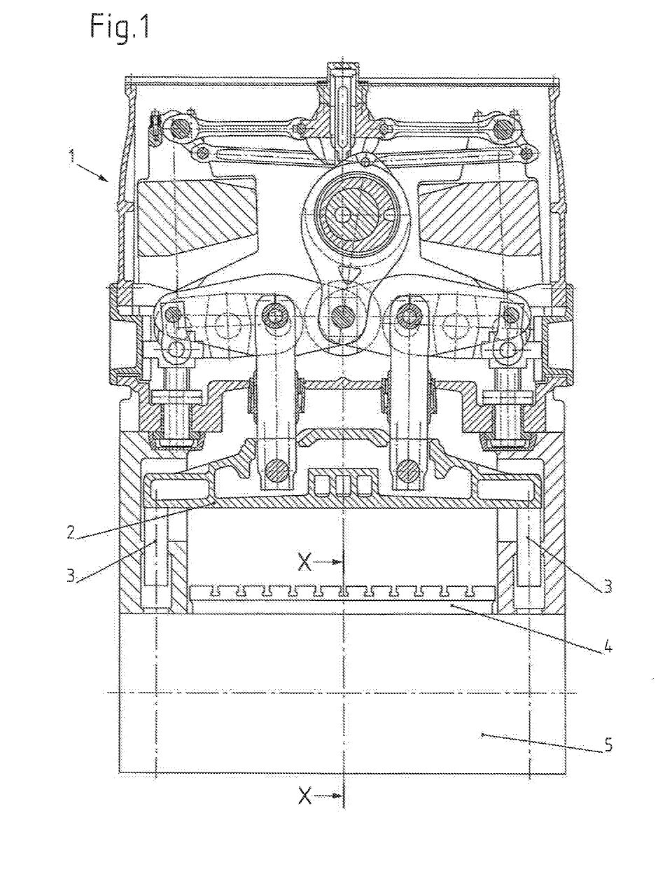

In FIG. 1, an automatic punching machine with top drive is shown wherein the top part of the machine is shown in section in longitudinal direction with the drive unit 1, the ram 2 and the ram guides 3, whereas the bottom part of the machine is shown not in section with the clamping plate 4 and the machine bed 5.

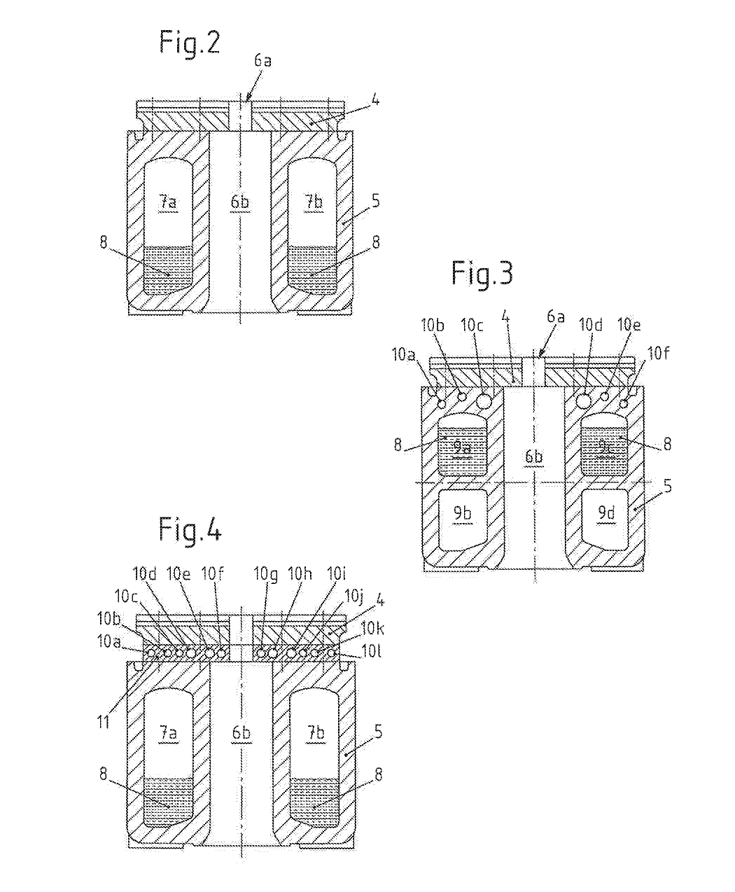

FIG. 2 shows a section through the bottom part of the machine of the automatic punching machine along the line X-X in FIG. 1, as designed according to prior art. As can be seen, the clamping plate 4 is arranged on the machine bed 5 and has centrally an aperture 6a, which in the direction of gravity leads into an aperture 6b arranged centrally in the machine bed 5. The apertures 6a, 6b serve for carrying away punching parts and rubbish out of the punching zone.

As can be seen further, the machine bed 5 to both sides of the aperture 6b forms a closed cavity 7a, 7b in each case, which cavity serves as a tank for the lubricating oil 8 of the lubricating oil circuit of the automatic punching machine. During operation, the machine bed 5 is heated by the heated lubricating oil 8 more in its lower part than in its upper part by means of which it already warps down without punching force load through different thermal expansion. Under the load of the punching force, there is an additional bending of the machine bed 5 during operation, and subsequently there is a corresponding loss of precision and an increased tool wear.

FIG. 3 shows a section through the bottom part of the automatic punching machine along the line X-X in FIG. 1, as it is designed according to a first embodiment of the invention. As can be seen, the outer contours of the clamping plate 4 and the machine bed 5 are identically here to the embodiment according to FIG. 2. However, the inner structure of the machine bed 5 differs clearly from that in FIG. 2. In the present case, the machine bed 5 in each case forms at both sides each of the aperture 6b two closed cavities 9a, 9b; 9c, 9d arranged one upon the other, out of which in each case only the upper ones 9a, 9c serve as tank for the lubricating oil 8 of the lubricating oil circuit of the automatic punching machine. Above the cavities 9a, 9b; 9c, 9d, the machine bed 5 at both sides each of the aperture 6b in each case has three flow channels 10a, 10b, 10c; 10d, 10e, 10f arranged side by side, out of which in each case the flow channels 10c, 10d arranged closest to the aperture 6b have a clearly bigger flow cross-section than the remaining flow channels 10a, 10b, 10e, 10f. The flow channels 10a-10f are flowed through by the heated lubricating oil 8 of the lubricating oil circuit of the automatic punching machine during operation, which lubricating oil subsequently is guided into the cavities 9a, 9c, wherefrom it is passed again to the lubrication points of the automatic punching machine by the lubricating oil pump of the lubricating oil circuit, if applicable after previously going through a cooling device. Thereby, the heated lubricating oil 8 is passed firstly through the flow channels 10c, 10d arranged closest to the aperture 6b, then through the central flow channels 10b, 10e and at the end through the outer flow channels 10a, 10f, thereby transferring heat to the machine bed 5. Hereby, the machine bed 5 is heated more in its upper area than in its lower area during operation, by means of which the machine bed due to different thermal expansion warps upwards and therefore in the direction towards the ram 2.

Thereby, the machine bed 5 is heated more in the areas adjacent to the aperture 6b than in the areas at its longitudinal sides as a consequence of the sequential arrangement of the flowing through the flow channels and of the different flow channel cross-sections, which leads to a stronger warp of it upwards in the areas adjacent to the aperture 6b.

The clamping plate 4, which is fixed on the machine bed 5 by a plurality of screw connections, follows the warp of the machine bed 5. During operation, under the load of the punching forces, there is a compensation of this warp caused by thermal expansion such that the machine bed 5 is flat in the ideal case under maximal punching force load both in longitudinal and in cross direction, i.e. not warped or not bended, respectively. Hereby, it can effectively be counteracted a loss of punching precision and an increased tool wear.

FIG. 4 shows a section through the bottom part of the machine of the automatic punching machine along the line X-X in FIG. 1, like it is designed according a second embodiment of the invention. As can be seen, the outer contours of the clamping plate 4 and of the machine bed 5 are identical here to the embodiment according to FIG. 2, and also the inner structure of the machine bed 5 is identical to that of the machine bed of FIG. 2. However, an intermediate plate 11 is arranged here between the clamping plate 4 and the machine bed 5 with a plurality of flow channels 10a-10l, which are flown through by a warm water circuit during operation, e.g. from a re-cooling device of the lubricating oil circuit of the automatic punching machine. Thereby, the warm water is passed firstly through the flow channels 10d, 10e, 10h, 10i which are closest to the boundaries of the aperture 6b in the machine bed 5, then through the inner and central flow channels 10c, 10f, 10g, 10j arranged beside them and at the end through the outer flow channels 10a, 10b, 10k, 10l. Thereby, the intermediate plate 11 is heated by the warm water circuit and heats on its part the contact face of the machine bed 5 and of the clamping plate 4 adjacent to it. Hereby again, the machine bed 5 is heated more in its upper part than in its bottom part by means of which it warps upwards, i.e. in the direction towards the ram 2, as a consequence of different thermal expansions.

Because here the heating by the flow channels 10d, 10e, 10h, 10i arranged closest to the boundaries of the aperture 6b is the strongest, the machine bed 5 warps in the areas adjacent to the aperture 6b more upwards than in the areas of the longitudinal sides which are heated less strong by the outer flow channels 10a, 10b, 10k, 10l. The clamping plate 4, which is connected in a shear stiff manner with the machine bed 5 over the intermediate plate 11 and which is built of a material with a bigger heat expansion coefficient than the material of the machine bed 5, transfers additional shear forces into the machine bed 5 which increases the warp upwardly. Like at the embodiment according to FIG. 3, there is a compensation of this warp during operation under the load by the punching force, which in ideal case leads to a machine bed that is flat both in longitudinal and in cross direction under maximal punching load, i.e. not warped or bended, respectively. This solution has the advantage that existing machines with a corresponding intermediate plate 11 can be converted in a simple way into a punching press according to the invention.

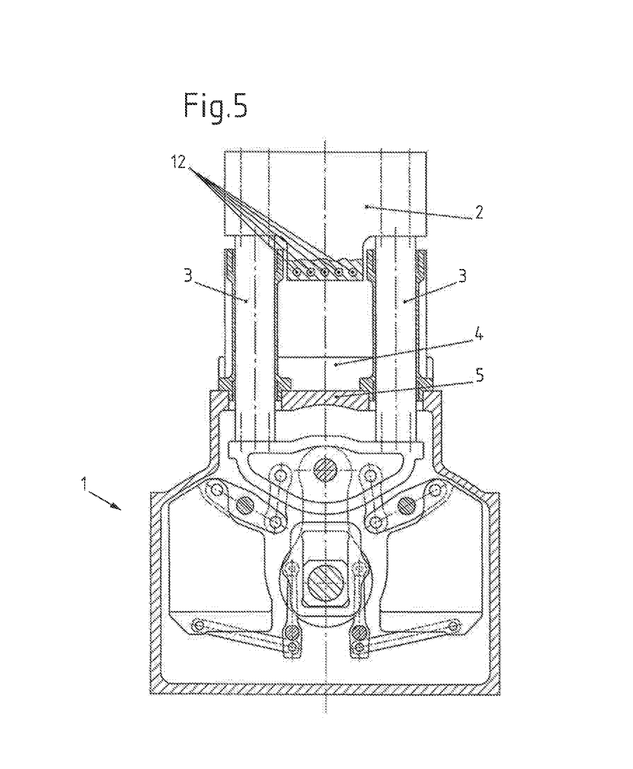

In FIG. 5, there is shown an automatic punching machine with top drive according to the invention, wherein the bottom part of the machine with the drive unit 1 is shown in section in cross direction and the ram 2 is shown partly in section. The clamping plate 4 is shown not in section.

As can be seen, the ram 2, which is driven and guided by a pull columns 3, has several longitudinal bores in the area of its bottom side, which are penetrated by heat resisting elements 12. These are charged with electric current during operation, by means of which the ram 2 is heated more in the area of its bottom side than in the upper area and warps as a consequence due to different thermal expansions downwardly, i.e. in the direction towards the machine bed 5. During operation, there is a compensation of this warp caused by thermal expansion under the load of the punching force such that the ram 2 in ideal case is straight, i.e. not warped or not bended, respectively, under maximal punching force load. Hereby, it can be counteracted effectively to a loss of punching precision and to an increased tool wear.

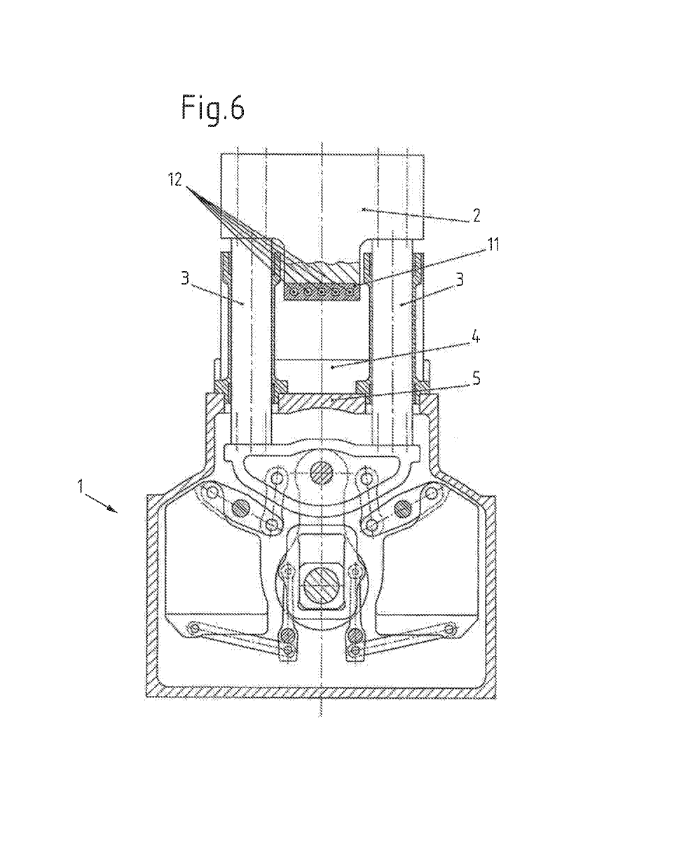

FIG. 6 shows a further automatic punching machine with top drive according to the invention which only differs from that shown in FIG. 5 in that heating elements 12 are not arranged in the ram 2 here, but in an intermediate plate 11 which serves for fixation of the upper tool elements at the ram 2. The effect achieved hereby is identical as described before, but this solution has the advantage that existing machines with corresponding intermediate plates 11 can be converted in a simple way to a punching machine according to the invention. While there are shown and described presently preferred embodiments of the invention, it is to be distinctly understood that the invention is not limited thereto but may be otherwise variously embodied and practiced within the scope of the following claims.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. A method for warping a machine bed and/or a press ram of a punching press to compensate at least partially a bending caused by the punching force during punching operation, wherein a temperature gradient is produced within the machine bed or a supporting structure for the lower tool elements built with the machine bed, respectively, and/or within the press ram or a supporting structure for the upper tool elements built with the press ram, respectively, with the effect of making the machine bed warping in the direction towards the press ram and/or of making the press ram warping in the direction towards the machine bed.

2. The method according to claim 1, wherein the temperature gradient is produced by heating the machine bed in the area of its side facing the press ram and/or by heating the press ram in the area of its side facing the machine bed.

3. The method according to claim 2, wherein for heating, electrical heating elements arranged within the machine bed and/or within the press ram are charged with electric current for producing the temperature gradient.

4. The method according to claim 1, wherein the temperature gradient is produced by cooling the machine bed in the area of its side facing away from the press ram and/or by cooling the press ram in the area of its side facing away from the machine bed.

5. The method according to claim 1, wherein for producing the temperature gradient, flow channels arranged within the machine bed and/or within the press ram are flowed through by a heated or cooled, gaseous or liquid medium.

6. The method according to claim 5, wherein heated lubricating oil of a lubricating oil circuit of the punching press is conducted through the flow channels.

7. The method according to claim 1, wherein a clamping plate arranged on the machine bed exists, which clamping plate is heated, for warping the machine bed in the direction towards the press ram due to a heating of it by the clamping plate at its side facing the ram and/or for warping the machine bed in the direction towards the press ram due to an introduction of shear forces produced by a thermal expansion of the clamping plate into the side of the machine bed facing the ram.

8. The method according to claim 1, wherein a clamping plate arranged on the machine bed exists and a heating device arranged between the machine bed and the clamping plate, which is heated, for warping the machine bed in the direction towards the press ram due to a heating of it by the heating device at its side facing the ram and/or for warping the machine bed in the direction towards the press ram due to a heating of the clamping plate by the heating device and an introduction of shear forces produced by a thermal expansion of the clamping plate into the side of the machine bed facing the ram.

9. The method according to claim 1, wherein the machine bed has an aperture for carrying away punched parts and rubbish, and wherein the temperature gradient within the machine bed is produced such that the machine bed warps stronger in the area adjacent to the aperture in the direction towards the press ram than in the areas adjacent to its longitudinal sides.

10. The method according to claim 2, wherein the machine bed in the area of its side facing the press ram is heated stronger near to the boundaries of the aperture than near to its longitudinal sides.

11. The method according to claim 3, wherein the machine bed in the area of its side facing away from the press ram is cooled stronger near to the boundaries of the aperture than near to its longitudinal sides.

12. The method according to claim 1, wherein the warping of the machine bed and/or of the press ram is adjusted as a function of parameters of the punching operation, in particular as a function of a calculated or measured maximal punching force, and in particular, wherein the warping is adjusted during the intended operation of the press.

13-28. (canceled)

29. A punching press, in particular for conducting the method according to claim 1, with a machine bed and with a press ram working against the machine bed,
wherein means exist for warping the machine bed in the direction towards the press ram and/or for warping the press ram in the direction towards the machine bed by producing a temperature gradient within the machine bed or a supporting structure for the lower tool elements built with machine bed and/or within the press ram or a supporting structure for the upper tool elements built with the press ram,
wherein the means for warping the machine bed and/or the press ram comprise flow channels arranged within the machine bed and/or within the press ram, which flow channels can be flown through by a heated or cooled, gaseous or liquid medium for producing the temperature gradient during the intended operation of the press and
wherein the press comprises a lubricating oil circuit and the means for warping the machine bed and/or the press ram comprise arrangements, by means of which heated lubricating oil of the lubricating oil circuit can be passed through the flow channels during the intended operation of the press.

30. The punching press according to claim 29, wherein the means for warping the machine bed and/or the press ram are built to heat the machine bed in the area of its side facing the press ram and/or to heat the press ram in the area of its side facing the machine bed.

31. The punching press according to claim 30, wherein the means for warping the machine bed and/or the press ramp comprise electric heating elements arranged within the machine bed and/or the press ram, which heating elements can be charged with electric current during the intended operation of the press, for producing the temperature gradient.

32. The punching press according to claim 29, wherein the means for warping the machine bed and/or the press ram are built for cooling the machine bed in the area of its side facing away from the press ram and/or for cooling the press ram in the area of its side facing away from the machine bed.

33. The punching press according to claim 29, wherein the punching press comprises means for warping the machine bed and wherein a clamping plate is arranged on the machine bed, which can be heated with the means for warping the machine bed during the intended operation of the press, for producing the temperature gradients by heating the machine bed at its side facing the ram by the clamping plate.

34. The punching press according to claim 29, wherein the punching press comprises means for warping the machine bed and wherein a clamping plate is arranged on the machine bed, which clamping plate can be heated by the means for warping the machine bed during the intended operation of the press and which clamping plate is connected with the machine bed such that it can transfer shear forces to the machine bed, for warping the machine bed in the direction towards the press ram due to an introduction of shear forces produced by a thermal expansion of the clamping plate into the side of the machine bed facing the ram.

35. The punching press according to claim 34, wherein a thermal insulation layer exists between the clamping plate and the machine bed, for reducing a heat transfer from the clamping plate to the machine bed.

36. The punching press according to claim 29, wherein the punching press comprises means for warping the machine bed and wherein a clamping plate is arranged on the machine bed and wherein the means for warping the machine bed comprise a heating device arranged between the machine bed and the clamping plate, which can be operated during the intended operation of the press, for warping the machine bed due to a heating of it at its side facing the ram.

37. The punching press according to claim 29, wherein the punching press comprises means for warping the machine bed and wherein a clamping plate is arranged on the machine bed, which is connected with the machine bed such that it can transfer shear forces to the machine bed, and wherein the means for warping the machine bed comprise a heating device arranged between the machine bed and the clamping plate, which heating device can be operated during the intended operation of the press, for warping the machine bed in the direction towards the press ram due to an introduction of shear forces produced by a thermal expansion of the clamping plate into the side of the machine bed facing the ram.

38. The punching press according to claim 29, wherein the punching press comprises means for warping the machine bed and wherein the machine bed has an aperture for carrying away punched parts and rubbish, and wherein the means for warping the machine bed are built such that they warp the machine bed stronger in the area adjacent to the aperture than in the areas adjacent to the longitudinal sides of the machine bed.

39. The punching press according to claim 30, wherein the means for warping the machine bed are built to heat the machine bed in the area of its side facing the press ram near to the boundaries of the aperture or to heat it stronger in that area than near to its longitudinal sides, respectively.

40. The punching press according to claim 30, wherein the means for warping the machine bed are built to cool the machine bed in the area of its side facing away from the press ram near to the boundaries of the aperture or to cool it stronger in this area than near to its longitudinal sides, respectively.

41. The punching press according to claim 29, wherein the means for warping the machine bed and/or the press ram are built adjustable, in particular during the intended operation of the press, for enabling a selective adjustment of the warping of the machine bed and/or of the warping of the press ram.

42. The punching press according to claim 29, wherein the punching press comprises a press control unit, by means of which the warping of the machine bed and/or of the press ram, in particular automatically, in function of parameters of the punching process can be adjusted, in particular in function of a calculated or measured maximal punching force, and in particular can be adjusted during the intended operation of the press.
